(19) United States
(12) Patent Application Publication
(10) Pub. No.: US 2002/0174720 A1
(43) Pub. Date: Nov. 28, 2002

(54) MEMS gyroscope and accelerometer with mechanical reference

(76) Inventor: Donato Cardarelli, Medfield, MA (US)

Correspondence Address: MIRICK O'CONNELL, 1700 WEST PARK DRIVE, WESTBOROUGH, MA, 01581-3941, US

(21) Appl. No.: 10/124,794

(22) Filed: Apr. 17, 2002

Related U.S. Application Data
(60) Provisional application No. 60/284,348, filed on Apr. 17, 2001.

(51) Int. Cl. G01P 15/08

(52) U.S. Cl. 73/504.02; 73/504.08

(57) ABSTRACT

This invention describes the addition of mechanical reference members (MRM) to MEMS gyroscopes and accelerometers in order to enable the measurement of their scale factor and bias characteristics. The measurements can be made prior to or during operation of the instruments. This approach is attractive since MEMS devices are subject to drift of these characteristics with time, with the environment and with application conditions. The mechanical reference members are used to provide a rotation rate reference for the gyroscopes and an acceleration reference for the accelerometers.

### CROSS-REFERENCE TO RELATED APPLICATION

This application claims priority of provisional application No. 60/284,348, filed on Apr. 17, 2001.

### BACKGROUND OF INVENTION

Typically, gyroscopes and accelerometers are tested on stable test tables/stations that can provide precise inputs to determine the scale factor and bias characteristics of the instrument. This is an accurate method for factory/baseline instrument testing. The factory can test a large quantity of devices simultaneously to spread the high cost of testing. However, when MEMS devices are in the field, since they are low cost, they cannot economically be re-tested due to the high cost of factory testing. A built-in test approach is needed to monitor the scale factor and bias characteristics as they drift with time, temperature and due to application conditions.

Present approaches measure the instrument characteristics fully at the factory over ranges of temperatures and vibrations and other testable environments. The data is then used to compensate the instruments during operation, while also measuring the environment. The disadvantage of this approach for MEMS devices is that an insufficient amount of testing may have been done during testing for all the conditions that are likely to occur. In addition, MEMS devices are likely to be unstable and drift with time as stresses relieve themselves and as materials creep, and so forth. Time dependent drifts of the characteristics may be unpredictable.

### SUMMARY OF INVENTION

This invention relates to the addition of integral mechanical reference members (MRM) to MEMS gyroscopes and accelerometers in order to enable the measurement of their scale factor and bias characteristics. The measurements can be made prior to and/or during operation of the instruments. This approach is attractive since MEMS devices are subject to drift of these characteristics with time, with the environment and with application conditions. The mechanical reference member provides a rotation rate reference for the gyroscopes, and an acceleration reference for the accelerometers. The built-in/internal capability to measure the characteristics as needed would greatly reduce the up front testing and thus the instrument cost.

It is an object of this invention to add a mechanical reference member (MRM) to a MEMS gyroscope that allows the gyroscope to be rotated about its input axis at a known rotation rate (rotation angle with time). The mechanical member will be referred to herein as the Rotation Mechanical Reference Member (RMRM). By inputting different rotation rates, the gyroscope characteristics (scale factor and bias) can be determined.

It is a further object of this invention to rotate the RMRM according to a variety of input waveforms that describe rotation angle with time. One example is a ramp waveform that describes a constantly varying angle with time to a maximum angle; the waveform is then reset to zero angle and repeated. The input rate in this case is constant and can serve as a reference rotation rate value. By varying the ramp period, other reference rotation rates can be applied.

It is a further object of this invention to rotate the RMRM with a sinusoidal waveform that varies the rotation rate with time. In this case the rotation rate is varied from zero rotation rate to a maximum rotation rate that generates an output that varies sinusoidally from zero output to a maximum output. By varying the amplitude of the input rate oscillation, the linearity can be determined in addition to the gyroscope scale factor and bias.

It is a further object of this invention to add a mechanical reference member to a MEMS accelerometer that allows the accelerometer to be accelerated along its input axis. The mechanical reference member will be referred to herein as the Acceleration Mechanical Reference Member (AMRM). By inputting different acceleration levels, the accelerometer characteristics (scale factor and bias) can be determined.

It is a further object of this invention to accelerate the AMRM according to a variety of input waveforms that describe acceleration with time. A sinusoidal variation of acceleration with time produces a sinusoidal output with time. By varying the amplitude of the input acceleration oscillation, the scale factor and bias of the accelerometer can be determined.

It is a further object of this invention to add an integral member to the MEMS gyroscope that changes the input axis direction in order to remove the bias from the gyroscope data.

It is a further object of this invention to add an integral member to the MEMS accelerometer that changes the input axis direction in order to remove the bias from the accelerometer data.

This invention features an improved micro electromechanical systems (MEMS) gyroscope with an internal rotational reference, the gyroscope comprising a rotor member driven to oscillate about a rotor axis and coupled to an output member that is adapted to oscillate about an output axis that is orthogonal to the rotor axis, and means for resolving the oscillation about the output axis of the output member, the output member oscillation at least in part being induced by gyroscope rotation about a gyroscope input axis that is orthogonal to both the rotor axis and the output axis, the improvement comprising: an integral mechanical reference member flexurally coupled to the gyroscope and adapted to oscillate the gyroscope about the input axis; means for moving the mechanical reference member about the input axis; and means, responsive to the means for resolving, for determining the output member oscillation caused by the mechanical reference member oscillation, as a measure at least one of the scale factor and bias offset of the gyroscope.

The improvement may further comprise means for changing the orientation of the gyroscope input axis by 180 degrees to factor out bias offset from the input rate determination. The mechanical reference member movement about the input axis is preferably repetitive. Preferred motions are sinusoidal, a sawtooth, and a ramp.

The mechanical reference member may be coupled to the output member. In situations in which the gyroscope has an outer member, the mechanical reference member may be coupled to the outer member.

This invention also features an improved micro electromechanical systems (MEMS) gyroscope with an internal rotational reference, the gyroscope comprising a rotor member driven to oscillate about a rotor axis and coupled to an output member that is adapted to oscillate about an output axis that is orthogonal to the rotor axis, and means for resolving the oscillation about the output axis of the output member, the output member oscillation at least in part being induced by gyroscope rotation about a gyroscope input axis that is orthogonal to both the rotor axis and the output axis, the improvement comprising: an integral means for causing motion of the output member about the output axis; and means, responsive to the means for resolving, for determining the output member motion caused by the integral means, as a measure at least one of the scale factor and bias offset of the gyroscope.

Also featured is an improved micro electromechanical systems (MEMS) gyroscope with an internal rotational reference, the gyroscope comprising a rotor member driven to oscillate about a rotor axis and coupled to an output member that is adapted to oscillate about an output axis that is orthogonal to the rotor axis, and means for resolving the oscillation about the output axis of the output member, the output member oscillation at least in part being induced by gyroscope rotation about a gyroscope input axis that is orthogonal to both the rotor axis and the output axis, the improvement comprising: integral means for changing the orientation of the gyroscope relative to the input axis by 180 degrees, to provide for factoring out of the gyroscope bias.

The invention is also applicable to an improved micro electromechanical systems (MEMS) accelerometer with an internal acceleration reference, the accelerometer comprising a proof mass adapted to move along an input axis in response to acceleration, and means for resolving movement of the proof mass along the input axis, the improvement comprising: an integral mechanical reference member flexurally coupled to the accelerometer and adapted to move back and forth along the input axis; means for moving the mechanical reference member along the input axis, the movement causing movement of the proof mass along the input axis; and means, responsive to the means for resolving, for determining at least one of the scale factor and bias offset of the accelerometer.

In this aspect, the improvement may further comprise means for changing the orientation of the input axis by 180 degrees to factor out bias offset from the input acceleration determination. The mechanical reference member movement along the input axis is preferably repetitive. Preferred motions are sinusoidal, a sawtooth and a ramp.

The mechanical reference member may be coupled to the output member. In cases in which the accelerometer has an outer member, the mechanical reference member may be coupled to the outer member.

This invention also features an improved micro electromechanical systems (MEMS) accelerometer with an internal acceleration reference, the accelerometer comprising a proof mass adapted to move along an input axis in response to acceleration, and means for resolving movement of the proof mass along the input axis, the improvement comprising: integral means for causing motion of the proof mass along the input axis; and means, responsive to the means for resolving, for determining at least one of the scale factor and bias offset of the accelerometer.

Also featured is an improved micro electromechanical systems (MEMS) accelerometer with an internal acceleration reference, the accelerometer comprising a proof mass adapted to move along an input axis in response to acceleration, and means for resolving movement of the proof mass along the input axis, the improvement comprising: integral means for changing the orientation of the accelerometer relative to the input axis by 180 degrees, to provide for factoring out of the accelerometer bias.

Further featured in the invention is an improved micro electromechanical systems (MEMS) inertial instrument with an internal reference, the instrument comprising a first structure adapted to move relative to an input axis in response to motion, and means for resolving movement of the first structure relative to the input axis, the improvement comprising: an integral mechanical reference member flexurally coupled to the instrument and adapted to move relative to the input axis; means for moving the mechanical reference member relative to the input axis, the movement causing movement of the first structure relative to the input axis; means for resolving motion of the first structure relative to the input axis; and means, responsive to the means for resolving, for determining the scale factor and bias offset of the instrument.

### BRIEF DESCRIPTION OF DRAWINGS

Other objects, features and advantages will occur to those skilled in the art from the following descriptions of the preferred embodiments, and the accompanying drawings, in which:

FIG. 1 shows an Output versus Input characteristic with which gyroscope scale factor and bias are defined for this invention.

FIG. 2 shows an Output versus Input characteristic of this invention with superimposed oscillatory input and resulting oscillatory output.

FIG. 3 shows an Output versus Input characteristic of this invention with superimposed oscillatory input added to a DC input.

FIG. 4a illustrates how the flip of the input axis of this invention can be used to separate bias from the actual output according to this invention.

FIG. 4b illustrates, in a close-up view, how the bias is separated from the actual output.

FIG. 5 is a conceptual rendition of a MEMS gyroscope of this invention with a Rotation Mechanical Reference Member.

FIG. 6 is a conceptual rendition of a MEMS gyroscope of this invention with a Rotation Mechanical Reference Member and Flip Member that enables flip of the input axis by 180 degrees.

FIG. 7 is a conceptual rendition of a MEMS accelerometer of this invention with an Acceleration Mechanical Reference Member.

FIG. 8 is a conceptual rendition of a MEMS accelerometer of this invention with an Acceleration Mechanical Reference Member and Flip Member that enables flip of the input axis by 180 degrees.

FIG. 9 is a conceptual rendition of a MEMS gyroscope of this invention with a Rotation Member that rotates the gyroscope input axis into Zero Degrees Alignment and 180 Degrees Alignment.

FIG. 10 is a conceptual rendition of a second MEMS gyroscope of this invention with a Rotation Mechanical Reference Member.

FIG. 11 is a conceptual rendition of a second MEMS gyroscope of this invention with a Rotation Mechanical Reference Member and a Flip Member.

FIG. 12 is a conceptual rendition of a MEMS Tuned Flexure Accelerometer of this invention with an Acceleration Mechanical Reference Member.

FIG. 13 is a conceptual rendition of a MEMS Tuned Flexure Accelerometer of this invention with an Acceleration Mechanical Reference Member and a Flip Member.

### DESCRIPTION OF THE PREFERRED EMBODIMENTS

Mechanical Reference Member Mechanization

This invention may be accomplished with mechanical means added to gyroscopes and accelerometers to enable internal testing of at least scale factor and bias characteristics. The mechanical means introduces a known rotation rate to the gyroscope and a known acceleration to the accelerometer. The mechanical means preferably comprises a gimbal that rotates the gyroscope about the input axis, and a gimbal that allows the accelerometer to be translated along its input axis. The rotation and acceleration inputs are most likely repetitive (e.g. oscillatory), with an amplitude and frequency to be determined by the needs of the gyroscope and accelerometer; scale factor and bias are the primary characteristics, while non-linearity is also important. The amplitude of the oscillatory input needs to be known precisely or held constant relative to a voltage reference.

MEMS size and MEMS integration allows these mechanical members to be built into (i.e., integrated into) the instruments.

Modes of Operation

The mechanical reference inputs can be operated during an initializing phase prior to use, operated continuously before and during operation, or operated as needed.

Scale Factor and Bias Characteristics

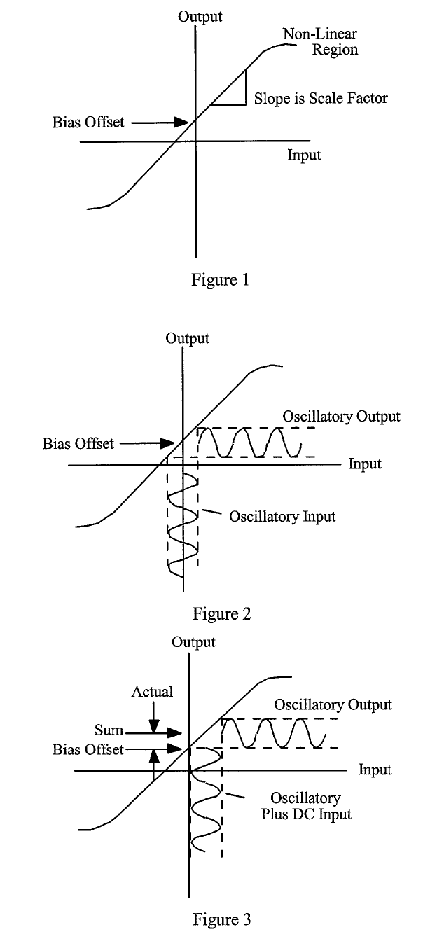

Scale factor and bias characteristics are common to the gyroscope and to the accelerometer. They are obtained by applying different inputs to the instruments and measuring the outputs. When the data is plotted, the scale factor is the slope of the linear region of the curve, and the bias is the offset, as shown in FIG. 1.

One method under the invention of measuring the scale factor and bias is to use a MRM to apply to the instrument a sinusoidal input, as shown in FIG. 2. The output is also sinusoidal. By taking the ratio of output amplitude to input amplitude, the scale factor is obtained. By processing the output signal to obtain the DC level, the bias is determined. The bias, however, can only be determined when zero input rate is applied.

The motion of the mechanical reference members determines the reference rotation rate and acceleration inputs applied.

Scale Factor and Bias Characteristics During Operation

During operation, the bias cannot be distinguished from the actual output. FIG. 3 shows the modification required to FIG. 2 to illustrate this case. The input is comprised of the actual input to be measured plus the reference oscillation used to measure the characteristics. The input oscillation is shown displaced in the horizontal direction. The output contains the oscillation that can be used to calculate the scale factor as was done for the zero input case of FIG. 2. The DC component of the output is the sum of the actual output plus the bias. The problem is that the bias can change during operation and therefore is assumed to be actual output. An additional procedure is thus needed to separate the bias from the actual output.

Separation of the Actual Output from Bias During Operation

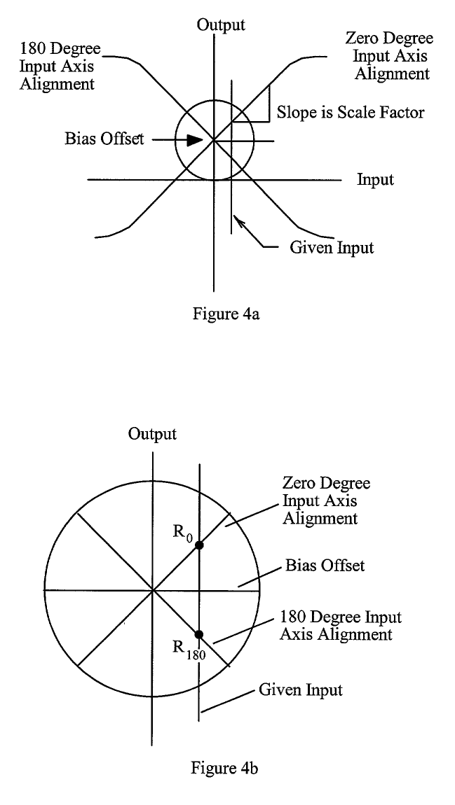

A different procedure is needed to separate the actual output from the bias during operation of the instrument. The procedure is to change the input axis orientation by 180 degrees. This has the effect of changing the sign of the output. Assuming that the procedure does not introduce an additional bias contribution, the bias should not change. FIG. 4a illustrates the characteristic for the initial input axis alignment, and for the 180 degrees re-alignment. Two output curves are shown with the same slopes but of opposite sign and that pass through the same bias. FIG. 4b is used to observe a close-up of the output for the case of a given input. R₀ is the output for the Zero Degrees Input Axis Alignment. R₁₈₀ is the output for the 180 Degrees Input Axis Alignment. The actual data is then obtained by (R₀−R₁₈₀)/2.

A second approach is to change the input over a small angle rather than through 180 degrees. The change in either case can be accomplished by any useful means, for example by flipping the instrument, or turning the instrument through the desired angular change (typically 180 degrees).

Accuracy of Mechanical Reference Member Motion

The accuracy of the mechanical reference member motion can be controlled relative to a voltage standard. An alternative approach is to include fiducials in the structures that are placed at known intervals (like marks on rulers). The mechanical reference member is controlled by measuring its motion relative to the fixed fiducials. Fiducials can include capacitive fingers, pits in the materials, reflective surfaces or magnetic writing, etc.

The invention relates to the addition of mechanical members to MEMS gyroscopes and accelerometers that enable two techniques for measuring the scale factor, bias and linearity characteristics of gyroscopes and accelerometer. The members are referred to as the Mechanical Reference Member and the Flip Member. The Rotation Mechanical Reference Member rotates the gyroscope about its input axis. The Acceleration Mechanical Reference Member translates the accelerometer along the input axis. The Flip Member rotates the input axis for both instruments from the zero degree alignment to the 180 degree alignment. The purpose is to change the sign of the output data.

MEMS Gyroscope with the Mechanical Reference Member

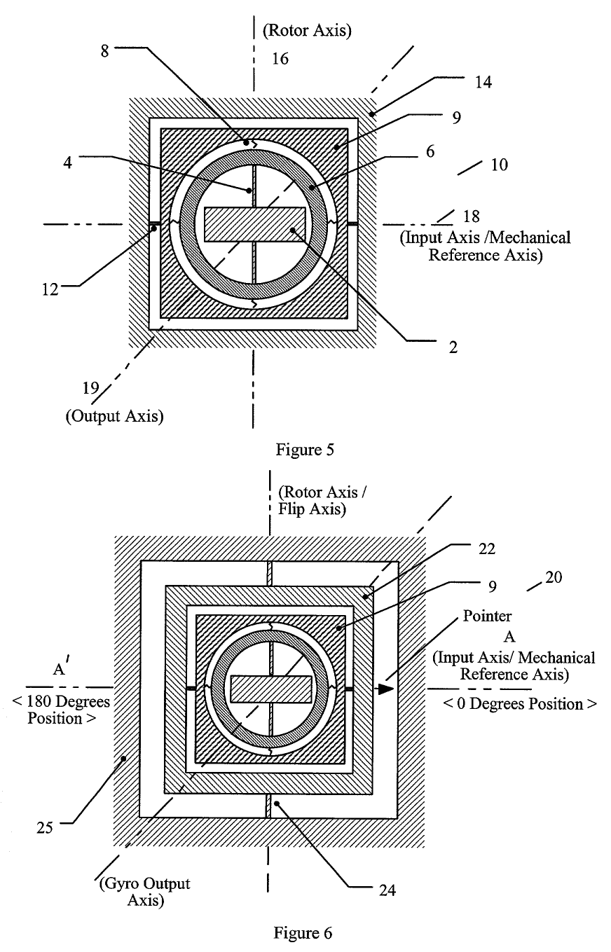

One MEMS gyroscope is described in U.S. Pat. No. 5,712,426, incorporated herein by reference. A MEMS gyroscope with integral reference member is shown in FIG. 5. Gyroscope 10 comprises the Rotor Member 2 connected with flexures 4 to Output Member 6 that is connected with flexures 8 to the Rotation Mechanical Reference Member (RMRM) 9. RMRM 9 is connected with flexures 12 to case 14.

During operation, Rotor Member 2 is oscillated sinusoidally at a frequency and amplitude about Rotor Axis 16. When case 14 is rotated about Input Axis 18, Output Member 6 responds with an oscillation about the Output Axis 19 with the same frequency, and with an amplitude that is proportional to the rotation rate input. The output then is the amplitude of the Output Member oscillation. For this configuration, the Rotor Member is oscillated out of-the-plane of the device, and the Output Member oscillates in the plane. Other configurations are possible, as explained more filly below. The input axis, output axis and rotor axis are mutually orthogonal.

To add a reference rotation rate about the Input Axis, the Rotation Mechanical Reference Member is actuated to rotate about the Input Axis. The Rotation Rate that is input depends on the application. A sinusoidal rotation rate input can be used to determine the scale factor and bias-at-rest. A constant Rotation Rate can be obtained with a sawtooth or ramp waveform. Different waveform periods can be used to vary the rotation rate input and obtain the gyroscope data from which the scale factor and bias are calculated.

MEMS Gyroscope with the RMRM and Flip Member

FIG. 6 shows the gyroscope of FIG. 5 with the Rotation Mechanical Reference Member (RMRM) 9. RMRM 9 is connected to Flip Member 22 rather than to case 25. Flip Member 22 is connected by flip mechanisms 24 to case 25. When Flip Member 22 is activated to flip from the zero angle to the 180 degree angle orientation, the full gyroscope and RMRM are flipped. The pointer indicates the alignment between A (0 degree orientation) and A′ (180 degree orientation). A MEMS gyroscope can be designed with just the Flip Member and not the RMRM.

MEMS Accelerometer with the Acceleration Mechanical Reference Member

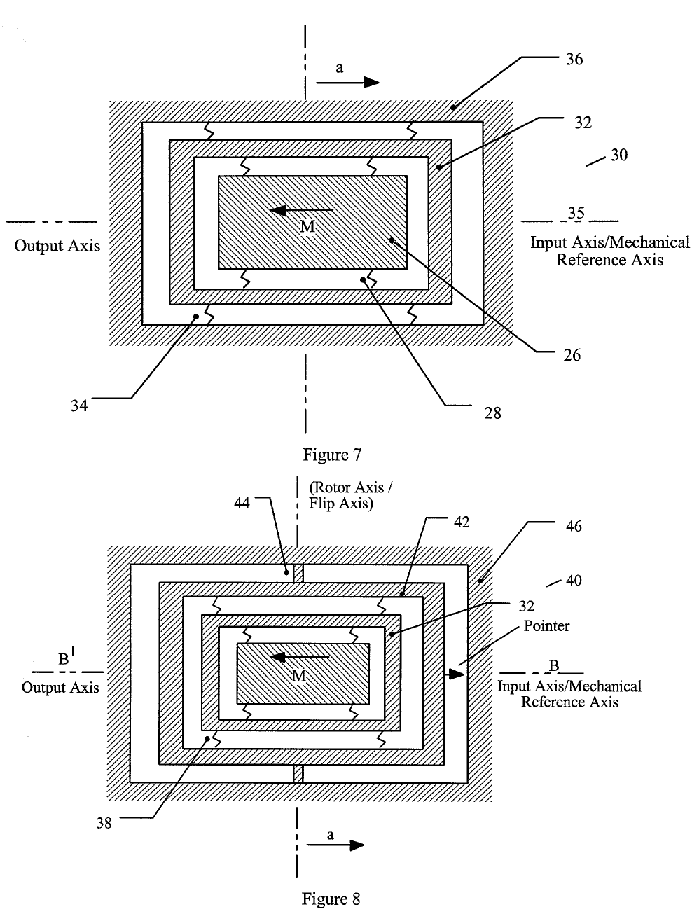

One MEMS accelerometer 30 is described in FIG. 7. It comprises Output Member (Mass) 26 connected with flexures 28 to Acceleration Mechanical Reference Member (AMRM) 32 that is connected with flexures 34 to case 36.

During operation, mass 26 responds to acceleration along Input Axis 35 to translate along the same axis and in the opposite direction. The sensed displacement of the mass relative to the AMRM is the output. To add reference acceleration to the mass, the AMRM is accelerated. Different accelerations can be used to determine the scale factor and bias. Alternatively, sinusoidal acceleration input can be used to determine the scale factor and bias.

MEMS Accelerometer with AMRM and Flip Member

FIG. 8 shows the accelerometer 40 of FIG. 7 with AMRM 32 connected with flexures 38 to Flip Member 42 rather than to case 46. Flip Member 42 is connected by flip mechanisms 44 to case 46. When Flip Member 42 is activated to flip from the zero angle to the 180 degree angle orientation, the full accelerometer and AMRM are flipped. The pointer indicates the alignment between the B and B′ positions. A MEMS accelerometer can be designed having just the Flip Member and not the AMRM.

Alternative to the Flip Member

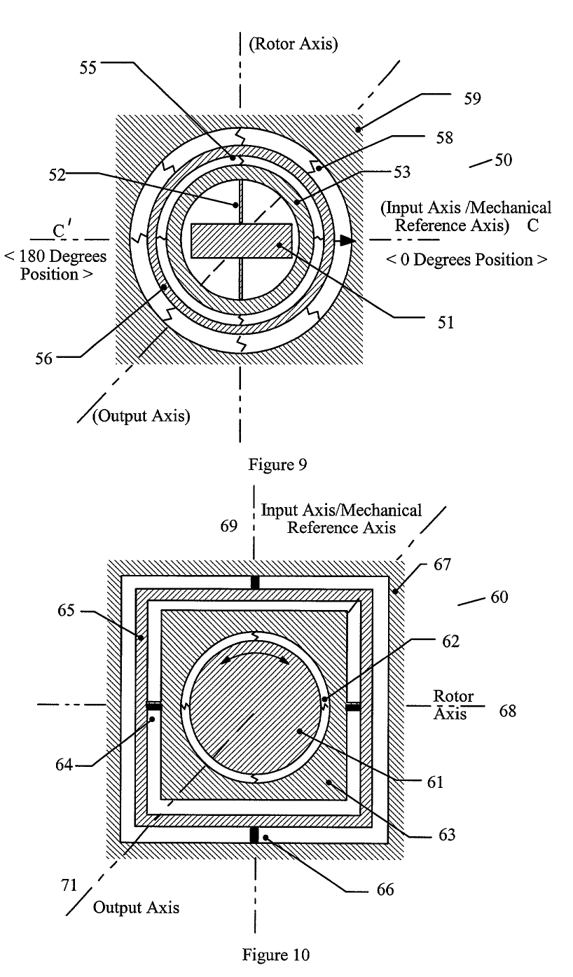

The function required to separate bias from actual output is to orient the instrument axis first along one axis and then in the opposite direction. The method described above to achieve this is to flip the gyroscope or accelerometer about the Flip Axis with the Flip Member as shown in FIGS. 6 and 8 for the gyroscope and accelerometer, respectively. An alternative method is to rotate the instrument in the plane using a Rotating Member as illustrated for the example of the gyroscope in FIG. 9. It applies to the accelerometer as well.

For this gyroscope 50, Rotor Member 51 is connected with flexures 52 to Output Member 53, that is connected with flexures 55 to Rotation Member 56. The RMRM is not shown in this example. Rotation Member 56 is connected with a rotating mechanism 58 to case 59. The pointer indicates alignment between the C and C′ position.

Alternative to Flip for the Isolation of Bias from Actual Rate

The essential flip between the negative- and positive-sloped characteristic can also be obtained without mechanically turning or flipping the gyroscope from the zero to the 180 degree orientations. Effectively this can also be done by changing the phase of the rotor oscillation by 180 degrees.

Application of Inventions to Non-MEMS Gyroscopes and Accelerometers

The invention is primarily applied to MEMS devices because the MEMS technology provides for integration of the invention into the instruments. The invention is also appropriate for MEMS devices because these are low cost devices that cannot be tested in the conventional way due to cost considerations. However, other miniature technologies may emerge for which the Mechanical Reference Members and Flip Member are practical, and the invention would apply to these also. In particular, nano gyroscopes and accelerometers are an example of a miniature technology in which the MRMS/Flip Members can be integrated.

This invention also applies to conventional instruments that are larger and more costly.

All MEMS Gyroscopes and Accelerometers

In the above description one gyroscope and one accelerometer were described with the added Mechanical Reference Member and Flip Member. However, the invention applies to all configurations and designs of gyroscopes and accelerometers.

Second Gyroscope

A second gyroscope 60 is illustrated in FIG. 10. Inner member 61 is attached by flexures 62 to Outer Member 63. Outer Member 63 is attached with flexures 64 to Rotation Mechanical Reference Member (RMRM) 65, that is attached with flip mechanisms 66 to case 67.

Operationally, the Outer Member oscillates about the Rotor Axis 68 thereby oscillating the Inner Member about the Rotor Axis. When subjected to rotation rate about the Input Axis 69, the Inner Member oscillates about Output Axis 71 with the same oscillation and with an amplitude proportional to the rotation rate. The RMRM rotates the gyroscope about the Input Axis at a known rate.

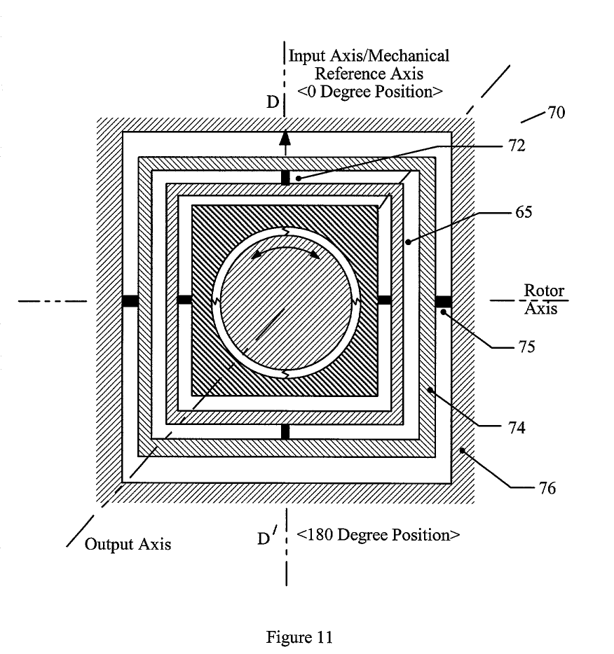

The gyroscope of FIG. 10 is repeated in FIG. 11 with the addition of an integral Flip Member. The RMRM 65 of Gyroscope 70 is connected with flexures 72 to Flip Member 74 instead of to the case. Flip Member 74 is connected with flip mechanisms 75 to case 76. The pointer indicates alignment between D (0 degree orientation) and D′ (180 degree orientation).

Second Accelerometer, Tuned Flexure Accelerometer

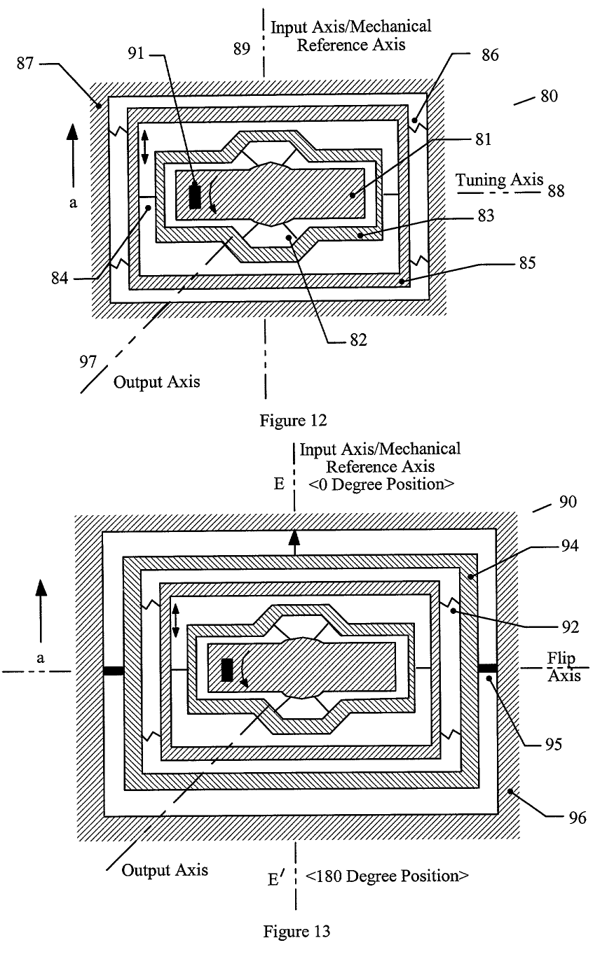

A second accelerometer 80 is illustrated in FIG. 12. See U.S. Pat. No. 6,338,274 B1, incorporated herein by reference, for a tuned flexure accelerometer. Inner member 81 is attached by flexures 82 to Outer Member 83. Outer Member 83 is attached with flexures 84 to Acceleration Mechanical Reference Member (AMRM) 85, that is attached with flip mechanisms 86 to case 87.

Operationally, Outer Member 83 oscillates about Tuning Axis 88, thereby oscillating Inner Member 81 about the same axis. When subjected to acceleration along Input Axis 89, Inner Member 81 is free to move about Output Axis 97 without restraint from flexures 82. A closed loop is used to hold Inner Member 81 at null. Inner Member 81 is made pendulous by adding mass 91 so that it can be sensitive to acceleration. The AMRM function is to translate the accelerometer along the Input Axis to introduce known accelerations.

The accelerometer of FIG. 12 is repeated in FIG. 13 with the addition of a Flip Member. The AMRM 85 of Gyroscope 90 is connected with flexures 92 to Flip Member 94 instead of to the case. Flip Member 94 is connected with flip mechanisms 95 to case 96. The pointer indicates alignment between E (0 degree orientation) and E′ (180 degree orientation).

Two Degree of Freedom Gyroscopes and Accelerometers

The invention also applies to two degree of freedom instruments, although the Mechanical Reference Member is in such cases replaced with two Mechanical Reference Members to allow inputs about both input axes.

Other embodiments will occur to those skilled in the art and are within the following claims:

What is claimed is:

1. An improved micro electromechanical systems (MEMS) gyroscope with an internal rotational reference, the gyroscope comprising a rotor member driven to oscillate about a rotor axis and coupled to an output member that is adapted to oscillate about an output axis that is orthogonal to the rotor axis, and means for resolving the oscillation about the output axis of the output member, the output member oscillation at least in part being induced by gyroscope rotation about a gyroscope input axis that is orthogonal to both the rotor axis and the output axis, the improvement comprising:
an integral mechanical reference member flexurally coupled to the gyroscope and adapted to oscillate the gyroscope about the input axis;
means for moving the mechanical reference member about the input axis; and
means, responsive to the means for resolving, for determining the output member oscillation caused by the mechanical reference member oscillation, as a measure at least one of the scale factor and bias offset of the gyroscope.

2. The improved micro electromechanical systems (MEMS) gyroscope with an internal rotational reference of claim 1, wherein the improvement further comprises means for changing the orientation of the gyroscope input axis by 180 degrees to factor out bias offset from the input rate determination.

3. An improved micro electromechanical systems (MEMS) gyroscope with an internal rotational reference, the gyroscope comprising a rotor member driven to oscillate about a rotor axis and coupled to an output member that is adapted to oscillate about an output axis that is orthogonal to the rotor axis, and means for resolving the oscillation about the output axis of the output member, the output member oscillation at least in part being induced by gyroscope rotation about a gyroscope input axis that is orthogonal to both the rotor axis and the output axis, the improvement comprising:
an integral means for causing motion of the output member about the output axis; and
means, responsive to the means for resolving, for determining the output member motion caused by the integral means, as a measure at least one of the scale factor and bias offset of the gyroscope.

4. An improved micro electromechanical systems (MEMS) accelerometer with an internal acceleration reference, the accelerometer comprising a proof mass adapted to move along an input axis in response to acceleration, and means for resolving movement of the proof mass along the input axis, the improvement comprising:
an integral mechanical reference member flexurally coupled to the accelerometer and adapted to move back and forth along the input axis;
means for moving the mechanical reference member along the input axis, the movement causing movement of the proof mass along the input axis; and
means, responsive to the means for resolving, for determining at least one of the scale factor and bias offset of the accelerometer.

5. The improved micro electromechanical systems (MEMS) accelerometer with an internal acceleration reference of claim 4, wherein the improvement further comprises means for changing the orientation of the input axis by 180 degrees to factor out bias offset from the input acceleration determination.

6. An improved micro electromechanical systems (MEMS) accelerometer with an internal acceleration reference, the accelerometer comprising a proof mass adapted to move along an input axis in response to acceleration, and means for resolving movement of the proof mass along the input axis, the improvement comprising:
integral means for causing motion of the proof mass along the input axis; and
means, responsive to the means for resolving, for determining at least one of the scale factor and bias offset of the accelerometer.

7. An improved micro electromechanical systems (MEMS) inertial instrument with an internal reference, the instrument comprising a first structure adapted to move relative to an input axis in response to motion, and means for resolving movement of the first structure relative to the input axis, the improvement comprising:
an integral mechanical reference member flexurally coupled to the instrument and adapted to move relative to the input axis;
means for moving the mechanical reference member relative to the input axis, the movement causing movement of the first structure relative to the input axis;
means for resolving motion of the first structure relative to the input axis; and
means, responsive to the means for resolving, for determining the scale factor and bias offset of the instrument.

8. The improved micro electromechanical systems (MEMS) gyroscope with an internal rotational reference of claim 1, wherein the mechanical reference member movement about the input axis is repetitive.

9. The improved micro electromechanical systems (MEMS) gyroscope with an internal rotational reference of claim 8, wherein the mechanical reference member movement about the input axis is sinusoidal.

10. The improved micro electromechanical systems (MEMS) gyroscope with an internal rotational reference of claim 8, wherein the mechanical reference member movement about the input axis is a sawtooth.

11. The improved micro electromechanical systems (MEMS) gyroscope with an internal rotational reference of claim 1, wherein the mechanical reference member movement about the input axis comprises a ramp.

12. The improved micro electromechanical systems (MEMS) gyroscope with an internal rotational reference of claim 1, wherein the mechanical reference member is coupled to the output member.

13. The improved micro electromechanical systems (MEMS) gyroscope with an internal rotational reference of claim 1, wherein the gyroscope has an outer member, and the mechanical reference member is coupled to the outer member.

14. The improved micro electromechanical systems (MEMS) accelerometer with an internal acceleration reference of claim 4, wherein the mechanical reference member movement along the input axis is repetitive.

15. The improved micro electromechanical systems (MEMS) accelerometer with an internal acceleration reference of claim 14, wherein the mechanical reference member movement along the input axis is sinusoidal.

16. The improved micro electromechanical systems (MEMS) accelerometer with an internal acceleration reference of claim 14, wherein the mechanical reference member movement along the input axis is a sawtooth.

17. The improved micro electromechanical systems (MEMS) accelerometer with an internal rotational reference of claim 4, wherein the mechanical reference member movement about the input axis comprises a ramp.

18. The improved micro electromechanical systems (MEMS) accelerometer with an internal acceleration reference of claim 14, wherein the mechanical reference member is coupled to the output member.

19. The improved micro electromechanical systems (MEMS) accelerometer with an internal acceleration reference of claim 14, wherein the accelerometer has an outer member, and the mechanical reference member is coupled to the outer member.

20. An improved micro electromechanical systems (MEMS) gyroscope with an internal rotational reference, the gyroscope comprising a rotor member driven to oscillate about a rotor axis and coupled to an output member that is adapted to oscillate about an output axis that is orthogonal to the rotor axis, and means for resolving the oscillation about the output axis of the output member, the output member oscillation at least in part being induced by gyroscope rotation about a gyroscope input axis that is orthogonal to both the rotor axis and the output axis, the improvement comprising:
integral means for changing the orientation of the gyroscope relative to the input axis by 180 degrees, to provide for factoring out of the gyroscope bias.

21. An improved micro electromechanical systems (MEMS) accelerometer with an internal acceleration reference, the accelerometer comprising a proof mass adapted to move along an input axis in response to acceleration, and means for resolving movement of the proof mass along the input axis, the improvement comprising:
integral means for changing the orientation of the accelerometer relative to the input axis by 180 degrees, to provide for factoring out of the accelerometer bias.
